(19) United States
(12) Patent Application Publication
(10) Pub. No.: US 2021/0271635 A1
(43) Pub. Date: Sep. 2, 2021

(54) FILE MANAGEMENT APPARATUS AND NON-TRANSITORY COMPUTER READABLE MEDIUM

(71) Applicant: FUJIFILM BUSINESS INNOVATION CORP., Tokyo (JP)

(72) Inventor: Rei YAMADA, Kanagawa (JP)

(73) Assignee: FUJIFILM BUSINESS INNOVATION CORP., Tokyo (JP)

(21) Appl. No.: 17/009,882

(22) Filed: Sep. 2, 2020

(30) Foreign Application Priority Data
Feb. 28, 2020 (JP) 2020-033242

(51) Int. Cl. G06F 16/14; G06F 16/16; G06F 16/2457; G06F 16/13

(52) U.S. Cl. CPC G06F 16/156; G06F 16/148; G06F 16/13; G06F 16/24578; G06F 16/164

(57) ABSTRACT

A file management apparatus includes: a memory configured to store multiple files in a state where a user-set attribute including an attribute name and an attribute value that are set by a user is added to each file; and a processor configured to cause a display device to display a screen when a user searches for any of the files by using an attribute name of the user-set attribute as a search condition, wherein, of the attribute names of the multiple user-set attributes set to the multiple files, the screen includes, in a selectable manner as a candidate for the search condition, an attribute name added to a file that has undergone an operation in the past by the user performing the search, and does not include an attribute name added only to a file that has never undergone an operation by the user performing the search.

### CROSS-REFERENCE TO RELATED APPLICATIONS

This application is based on and claims priority under 35 USC 119 from Japanese Patent Application No. 2020-033242 filed Feb. 28, 2020.

### BACKGROUND

### (i) Technical Field

The present disclosure relates to file management apparatuses and non-transitory computer readable media.

### (ii) Related Art

Japanese Unexamined Patent Application Publication No. 2010-086455 discloses a search-condition designating apparatus that presents a list of attributes corresponding to an attribute value designated as a search condition on an output device and receives designation of an attribute from the presented list of attributes, so as to reduce the workload involved in the designation of a search condition by the user and to facilitate the retrieval of a desired search target.

### SUMMARY

A file management apparatus that stores and manages files created by various users is provided with a function for searching for a file that matches a designated condition from among the stored files. An example of a search condition used for searching for a file is attribute information including an attribute name and an attribute value.

Examples of attribute information include not only attribute information in which an attribute name is preliminarily set in the file management apparatus, such as the document name, the creator, and the created date, but also attribute information called a user-set attribute in which an attribute name is freely settable by a user.

With regard to such a user-set attribute, the user is free to select what kind of a name is to be used as an attribute name. Therefore, various attribute names may be set by individual users, resulting in a large number of attribute names.

A screen of a user terminal executing a search command displays attribute names serving as candidates for the search condition in a manner such that any of these attribute names is selectable by the user. When all attribute names of user-set attributes are displayed as candidates on the screen, it is difficult for the user to determine which one of the attribute names should be selected for obtaining a search result including a desired file.

Aspects of non-limiting embodiments of the present disclosure relate to a file management apparatus and a non-transitory computer readable medium storing a program therein that facilitate a selecting process for an attribute name from which a search result including a desired file is obtained when a certain user performs a search for retrieving a file on which the user has performed an operation in the past, as compared with a case where the user is only provided with a screen that displays all attribute names of user-set attributes as candidates for a search condition.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a file management apparatus including: a memory configured to store a plurality of files in a state where a user-set attribute including an attribute name and an attribute value that are set by a user is added to each file; and a processor configured to cause a display device to display a screen when a user searches for any of the files by using an attribute name of the user-set attribute as a search condition, wherein, of the attribute names of the plurality of user-set attributes set to the plurality of files, the screen includes, in a selectable manner as a candidate for the search condition, an attribute name added to a file that has undergone an operation in the past by the user performing the search, and does not include an attribute name added only to a file that has never undergone an operation by the user performing the search.

### BRIEF DESCRIPTION OF THE DRAWINGS

Exemplary embodiments of the present disclosure will be described in detail based on the following figures, wherein:

FIG. 1 illustrates a system configuration of a file management system according to an exemplary embodiment of the present disclosure;

FIG. 2 is a block diagram illustrating a hardware configuration of a file management server according to an exemplary embodiment of the present disclosure;

FIG. 3 is a block diagram illustrating a functional configuration of the file management server according to the exemplary embodiment of the present disclosure;

FIG. 4 is a flowchart illustrating operation performed in the file management server according to this exemplary embodiment of the present disclosure when a file searching process is performed based on a designated attribute name;

FIG. 5 illustrates an example of a terminal apparatus displaying a search screen;

FIG. 6 illustrates a state where a user is selecting a “user-set attribute” item in the search screen;

FIG. 7 illustrates an example of the search screen when the “user-set attribute” item is selected by the user;

FIGS. 8A to 8C illustrate a state where the search screen displayed on the terminal apparatus is being operated;

FIGS. 9A and 9B illustrate a state where the search screen displayed on the terminal apparatus is being operated;

FIG. 10 illustrates an example of a display screen of the terminal apparatus displaying search results;

FIGS. 11A to 11C illustrate a state where the user is setting a reference date in the search screen;

FIGS. 12A and 12B illustrate a reason that attribute names displayed as candidates for a search condition are changed as a result of changing the reference date;

FIGS. 13A and 13B illustrate display examples where attribute names are displayed such that it is clear whether each attribute name has been added by a user or has been added before being stored in the system; and

FIG. 14 illustrates a state where a list of files given an attribute name is displayed on a pop-up menu as a result of the user simply placing a mouse over the attribute name displayed as a candidate for the search condition.

### DETAILED DESCRIPTION

Exemplary embodiments of the present disclosure will be described in detail below with reference to the drawings.

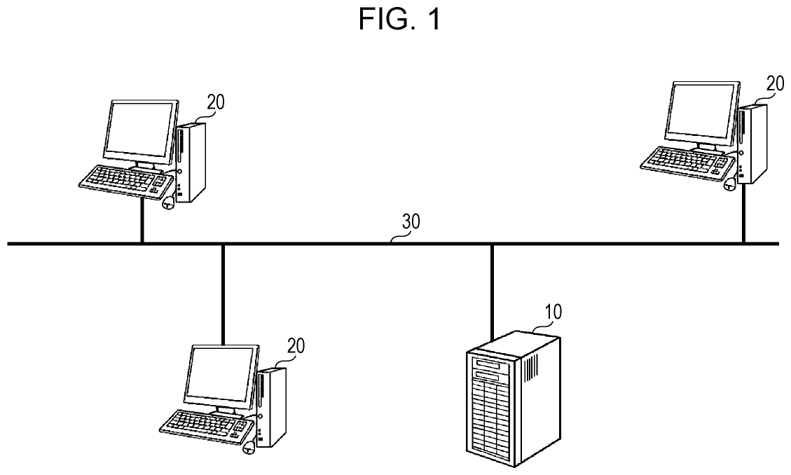

FIG. 1 illustrates a system configuration of a file management system according to an exemplary embodiment of the present disclosure.

As shown in FIG. 1, the file management system according to this exemplary embodiment includes multiple terminal apparatuses 20 and a file management server 10 that are connected by a network 30.

The file management server 10 is a file management apparatus that stores and manages files received from the terminal apparatuses 20. Each terminal apparatus 20 has file-management-system software installed therein and accesses the file management server 10 by activating this software, so as to be capable of storing and searching for files.

Examples of the files include document files, such as various types of Office files created using Microsoft (registered trademark) Office software, Portable Document Format (PDF) files of Adobe Systems Incorporated, and DocuWorks files created using Fuji Xerox (registered trademark) DocuWorks software. In addition to the document files mentioned above, the files include image files in Joint Photographic Experts Group (JPEG) and Portable Network Graphics (PNG) formats.

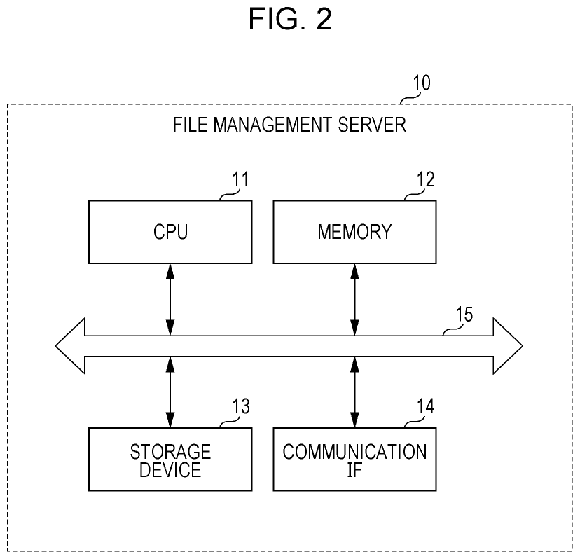

FIG. 2 illustrates a hardware configuration of the file management server 10 in the file management system according to this exemplary embodiment.

As shown in FIG. 2, the file management server 10 has a central processing unit (CPU) 11, a memory 12, a storage device 13, such as a hard disk drive, and a communication interface (abbreviated as “IF”) 14 that transmits and receives data to and from, for example, an external apparatus via the network 30. These components are connected to one another by using a control bus 15.

The CPU 11 is a processor that controls the operation of the file management server 10 by executing a predetermined process based on a control program stored in the memory 12 or the storage device 13. As an alternative to this exemplary embodiment in which the CPU 11 reads and executes the control program stored in the memory 12 or the storage device 13, the program may be provided to the CPU 11 by being stored in a storage medium, such as a CD-ROM.

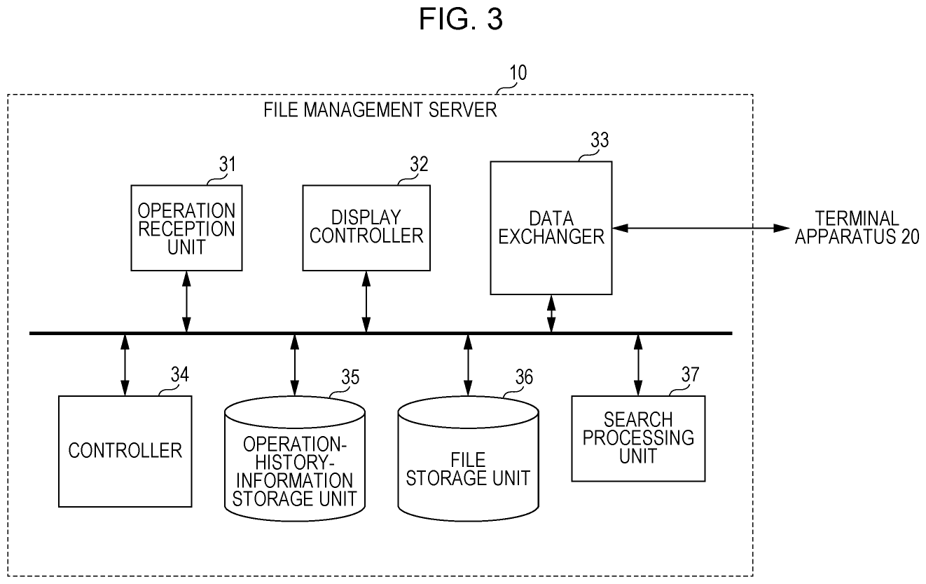

FIG. 3 is a block diagram illustrating a functional configuration of the file management server 10 realized by executing the aforementioned control program.

As shown in FIG. 3, the file management server 10 according to this exemplary embodiment includes an operation reception unit 31, a display controller 32, a data exchanger 33, a controller 34, an operation-history-information storage unit 35, a file storage unit 36, and a search processing unit 37.

The data exchanger 33 exchanges data with each terminal apparatus 20 via the network 30. The operation reception unit 31 receives various types of operations performed using each terminal apparatus 20. The display controller 32 controls a display screen to be displayed on a display device of each terminal apparatus 20. The data exchanger 33 receives a file to be stored in the file storage unit 36 from each terminal apparatus 20 based on an operation received by the operation reception unit 31.

The controller 34 controls the overall operation of the file management server 10 and controls, for example, the operation reception unit 31, the display controller 32, the data exchanger 33, and the search processing unit 37, so as to execute various types of processes, including storing files received from the terminal apparatuses 20, searching for files, and displaying search results.

In the file management server 10, files created by multiple users are stored in the file storage unit 36, and operation history information indicating the history of operations performed on each of these files for each user is stored in the operation-history-information storage unit 35.

The file storage unit 36 stores multiple files received from the terminal apparatuses 20. The file storage unit 36 stores each of the multiple files in a state where a system-set attribute and a user-set attribute have been added thereto. The system-set attribute includes an attribute name preliminarily set by a file-management-system provider, and an attribute value thereof. Examples of the attribute name of the system-set attribute include a “file name”, a “creator”, and a “created date”. The user-set attribute includes an attribute name other than that of the system-set attribute and an attribute value thereof, and is set in accordance with, for example, the properties of a file to be managed by a user. In detail, it is conceivable that an attribute name “approval deadline” for managing a file of a document that requires approval may be set, or an attribute name “drawing ID” for managing a file of a drawing may be set. Other examples of the attribute name of the user-set attribute include an attribute name added to a file before the file is stored in the file storage unit 36 and an attribute name added to a file after the file is stored in the file storage unit 36. The kind of attribute name provided as an attribute name of the system-set attribute varies depending on the system. The “file name”, “creator”, or “created date” exemplified above does not necessarily correspond to an attribute name of the system-set attribute. Furthermore, it may be regarded that the system-set attribute is automatically added to any file in the file storage unit 36 while including a case where the attribute value is “null”, whereas the user-set attribute is added only to a file to which the user-set attribute is explicitly added by the user.

Based on a search request from any of the terminal apparatuses 20, the search processing unit 37 searches the file storage unit 36 for a file that matches designated search conditions, such as the file name, creator, updater, created date, updated date, and user-set attribute.

Then, when the user desires to search for the file by using the attribute name of the user-set attribute as a search condition, the display controller 32 causes the display device of the terminal apparatus 20 to display a screen based on control by the controller 34, such that the screen includes, as a candidate for the search condition, an attribute name added to a file that has undergone an operation in the past by the user performing the search and does not include an attribute name added only to a file that has never undergone an operation by the user. Such attribute names are included in multiple attribute names of user-set attributes set to multiple files.

Examples of the operation performed on the file by the user include an operation performed by the user for changing the location of the file in the file storage unit 36, an operation for ascertaining the contents of the stored file, and an operation for changing information related to the stored file. Examples of the operation for changing the location of the file in the file storage unit 36 include an operation for newly storing the file in the file storage unit 36, an operation for deleting the file stored in the file storage unit 36, and an operation for changing the storage location by moving the file within the file storage unit 36. Examples of the operation for ascertaining the contents of the stored file include an operation for downloading the stored file and an operation for browsing the stored file. Examples of the operation performed by the user for changing the information related to the stored file include an operation for editing the contents of the stored file, an operation for changing the attribute value added to the stored file, and an operation for adding a new user-set attribute to the stored file.

The attribute name to be displayed on the screen as a candidate for the search condition by the display controller 32 may be an attribute name added to a file that has undergone any one of the aforementioned types of operations, or may be limited to an attribute name added to a file that has undergone some types of operations. In detail, the attribute name may be limited to an attribute name added to a file that has undergone the “operation for ascertaining the contents of the stored file”, or may be limited to an attribute name added to a file that has undergone either one of the “operation for ascertaining the contents of the stored file” and the “operation for changing the information related to the stored file”. In either case, the screen does not include an attribute name added only to a file that has never undergone any type of operation in the past by the user performing the search.

The operation reception unit 31 is capable of receiving, from each terminal apparatus 20, an addition of a new user-set attribute to a file stored in the file storage unit 36. When an addition of a new user-set attribute is received, the controller 34 stores information regarding which user has added what type of user-set attribute to which file in the operation-history-information storage unit 35.

Thus, the display controller 32 performs display control such that the screen displayed to the user performing the file search includes an attribute name added to a file by another user different from the above user. Specifically, the display controller 32 displays, on the display device of the terminal apparatus 20, not only the attribute name added to the file by the user but also an attribute name added to the file by another user as a candidate for the search condition.

In that case, the display controller 32 displays the attribute names so as to clearly indicate whether each attribute name has been added by another user or by the user performing the search.

Furthermore, the display controller 32 displays the attribute names so as to clearly indicate whether each attribute name has been added before the file is stored in the file storage unit 36 or has been added after the file is stored in the file storage unit 36. The attribute name added before the file is stored in the file storage unit 36 is an attribute name preliminarily added to the file outside the file management system. For example, with regard to DocuWorks files, PDF files, and Office files, which are representative examples of document files, a user is capable of setting an attribute name and an attribute value to a file by editing the properties of the file. Thus, a user-set attribute may possibly be added to the file before the file is stored in the file storage unit 36.

Before receiving a search execution command, the display controller 32 displays a list of files that are given attribute information with an attribute name set therein as a result of an operation performed on the attribute name displayed as a candidate for the search condition. For example, when a mouse-over operation where the pointer of a mouse is placed over an attribute name displayed as a candidate for the search condition is performed, the display controller 32 displays a pop-up menu of a list of files having that attribute name.

In that case, the display controller 32 performs the display such that the list of files displayed in the pop-up menu only includes a file or files having undergone an operation in the past by the user.

Instead of displaying only a file or files having undergone an operation in the past by the user, the display controller 32 may perform the display such that the list of files displayed in the pop-up menu includes the file or files having undergone an operation in the past by the user with higher priority over a file or files never having undergone an operation by the user.

When the controller 34 searches for an attribute name of a user-set attribute added to a file that has undergone an operation in the past by the user, the controller 34 uses the operation history information stored in the operation-history-information storage unit 35 to retrieve and identify an attribute name added to a file that has undergone an operation by the user within a specific period. In this case, the target attribute name includes not only an attribute name added to the file after the file is stored in the file storage unit 36, but also an attribute name added to the file before the file is stored in the file storage unit 36. Furthermore, the controller 34 uses the operation history information stored in the operation-history-information storage unit 35 to distinguish whether the identified attribute name has been added by that user or by another user, and also to distinguish whether the identified attribute name has been added before the file is stored in the file storage unit 36 or has been added after the file is stored in the file storage unit 36. Then, the display controller 32 displays the attribute name identified by the controller 34 as a candidate for the search condition to the user performing the search.

If there are multiple types of operations, the controller 34 may retrieve and identify an attribute name added to a file that has undergone some types of the operations, and may display the identified attribute name as a candidate for the search condition.

The specific period during which the controller 34 searches for an attribute name may be set based on a set reference time point. For example, the controller 34 searches for an attribute name added to a file that has undergone an operation by the user performing the search within a preset period from the set reference time point, such as from one previous week, and the display controller 32 displays the attribute name on the display screen of the terminal apparatus 20.

Then, in an initial state where the user does not give any commands, the current time point or the current time is set as the reference time point. If the reference time point is changed by the user, the time point changed by the user is set as the reference time point.

Next, the operation of the file management server 10 according to this exemplary embodiment will be described in detail with reference to the drawings.

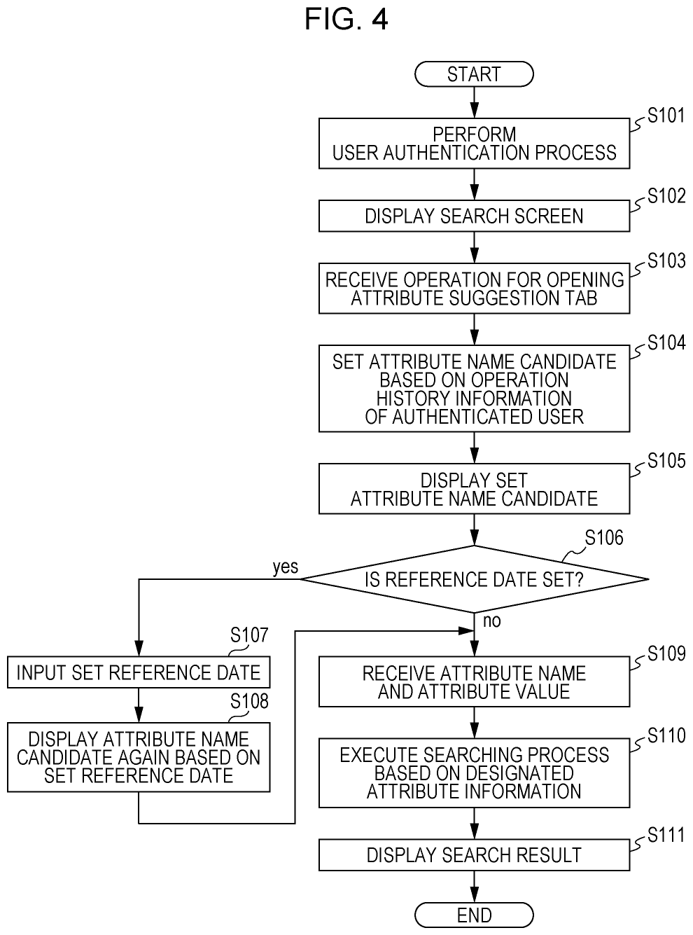

First, the operation performed in the file management server 10 according to this exemplary embodiment when a file searching process is performed based on a designated attribute name will be described with reference to a flowchart in FIG. 4.

When the file management server 10 receives an operation performed on any of the terminal apparatuses 20 by a user, a user authentication process is executed in step S101.

In step S102, the file management server 10 displays a search screen on the display screen of the terminal apparatus 20 of the user.

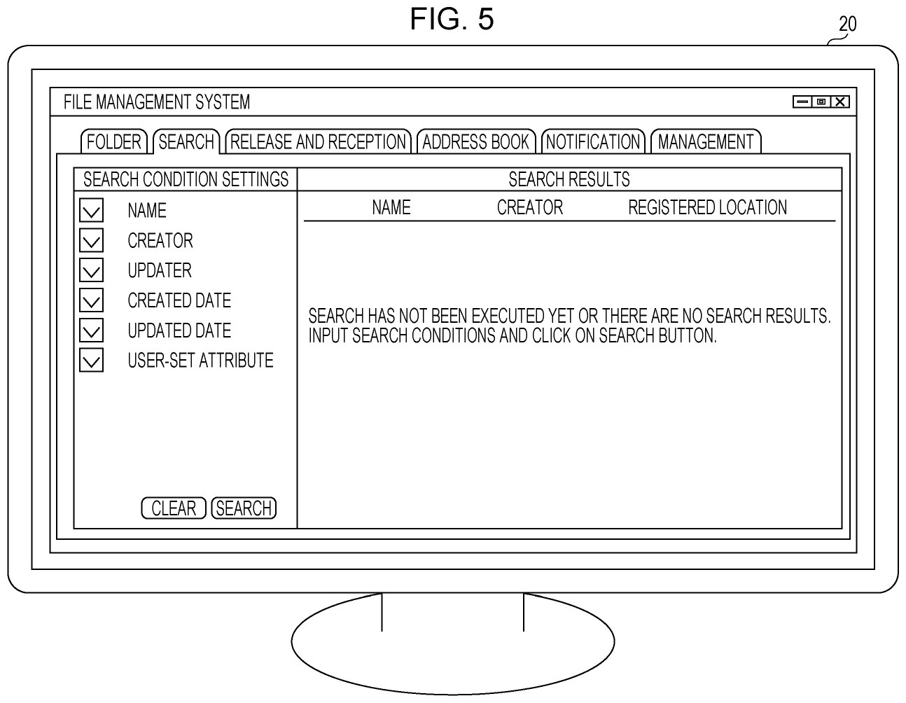

FIG. 5 illustrates an example of the terminal apparatus 20 displaying the search screen. Referring to FIG. 5, the search screen used for searching for a file is displayed on the display screen of the terminal apparatus 20 as a result of activating the file-management-system software and selecting a search tab.

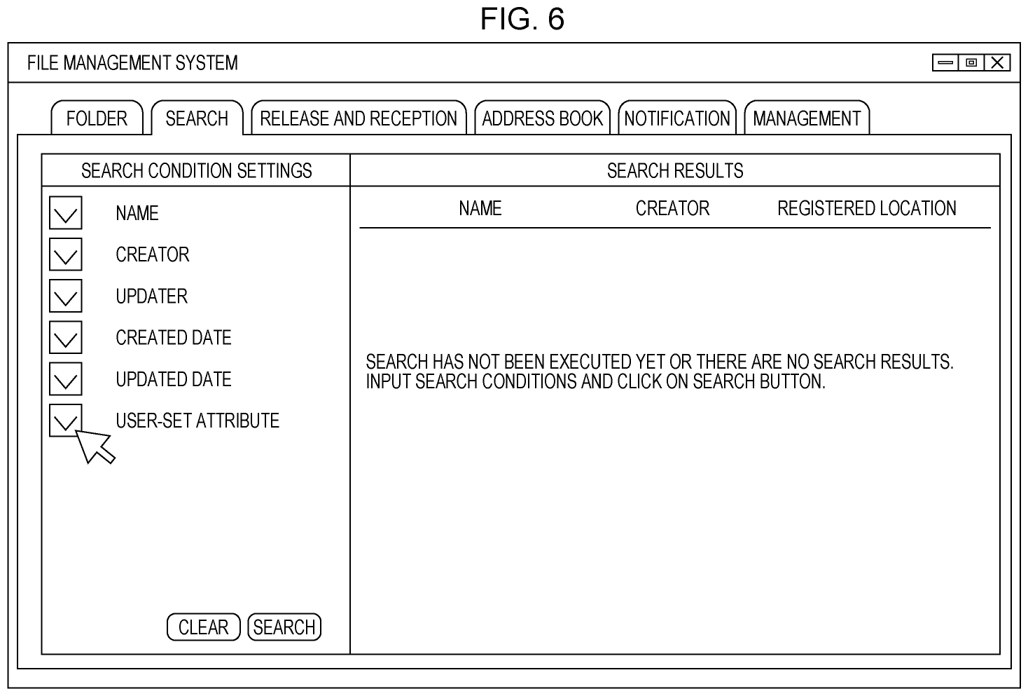

Then, when the user desires to search for a file by designating a user-set attribute as a search condition, the user selects a “user-set attribute” item in the search screen. FIG. 6 illustrates a state where the user is performing such an operation. Referring to FIG. 6, a state where the user is selecting the “user-set attribute” item by using a pointer is shown.

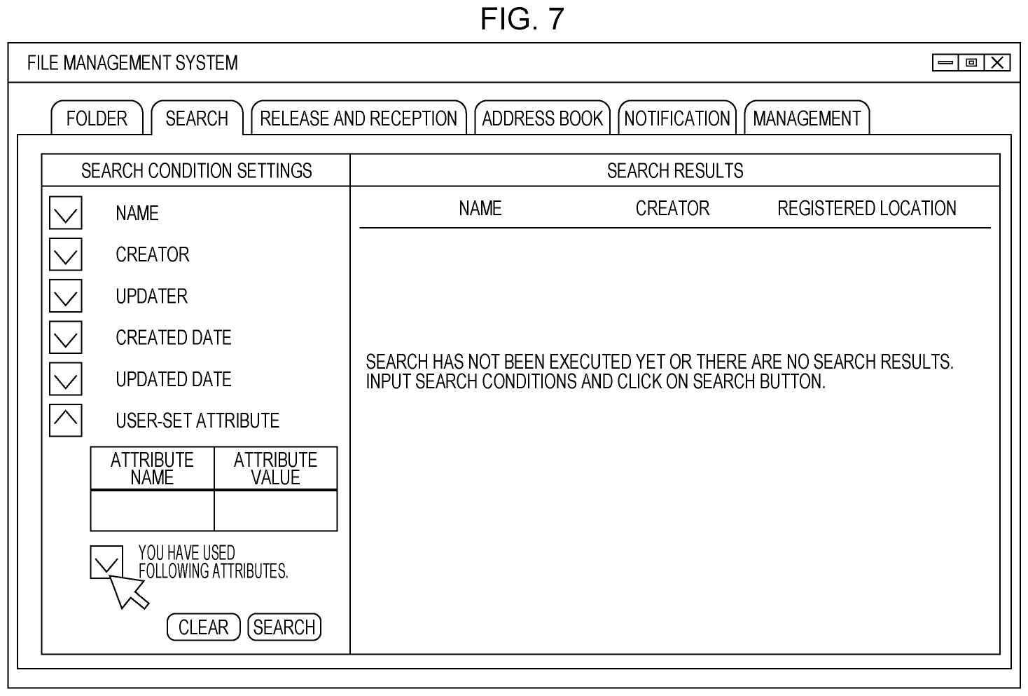

FIG. 7 illustrates an example of the search screen when the “user-set attribute” item is selected by the user. In the example of the search screen shown in FIG. 7, the “user-set attribute” item has been selected and an input field used for inputting an attribute name and an attribute value is shown.

The following relates to a conceivable case where the user desires to search for a file by inputting an attribute name but does not accurately remember the attribute name added to the file on which the user has performed an operation in the past. For example, it is assumed that the user performing the search desires to search for a file A that the user has browsed in the past or a file B related to the file A (i.e., a file managed using the same attribute name as the file A). If the file A and the file B are files given a user-set attribute (attribute name and attribute value) that allows for easier manageability by other users, there is a high possibility that the user performing the search does not accurately remember the attribute name of the user-set attribute. In such a case, the user performing the search selects an attribute suggestion tab. FIG. 7 illustrates a state where the user is opening an attribute suggestion tab displaying a character string “you have used following attributes”.

When the user performs such an operation, the file management server 10 receives the operation performed by the user for opening the attribute suggestion tab in step S103.

Then, in step S104, the file management server 10 searches for the attribute name of the user-set attribute added to the file that has undergone an operation in the past by the user based on past operation history information of the authenticated user, and sets the attribute name as an attribute name candidate for the search condition.

Then, in step S105, the file management server 10 displays the set attribute name candidate as a candidate for the search condition in a selectable manner on the display screen of the terminal apparatus 20.

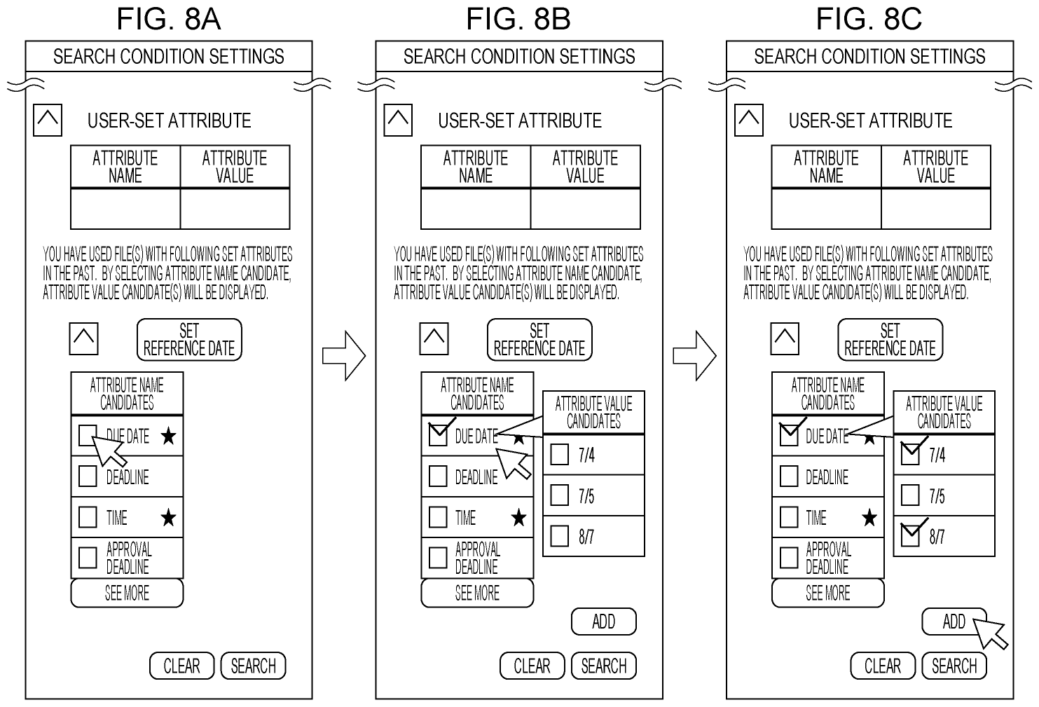

FIG. 8A illustrates an example of the search screen displaying attribute name candidates for the search condition. In FIG. 8A, attribute names “due date”, “deadline”, “time”, and “approval deadline” are displayed as candidates for the search condition. These attribute names may include not only attribute names added by the user performing the search, but also attribute names added by other users.

The order in which the attribute names are displayed as candidates for the search condition is set in advance. For example, the order may be set starting from an attribute name added to a file that has undergone an operation at the latest time and date. If there are multiple types of operations, the order may be set in accordance with priority levels based on the types of operations performed on files within a specific period. For example, the attribute names may be displayed sequentially in accordance with priority levels starting from an attribute name added to a browsed file, an attribute name added to a content-edited file, and an attribute name added to a file that has undergone an operation for changing the attribute value or for adding a new user-set attribute. Alternatively, the attribute names may be sequentially displayed starting from an attribute name added to a file that has undergone an operation most frequently within a specific period (e.g. a frequently-browsed file), or starting from an attribute name added commonly to the largest number of files among multiple files having undergone an operation within a specific period. Furthermore, multiple priority levels may be combined. If a certain number or more of attribute names are set as attribute name candidates for the search condition, only the attribute names at high priority levels may be displayed instead of displaying all of the attribute names at once, or all of the attribute names may be displayed in accordance with a command made by the user for changing the screen.

In FIG. 8A, when the user selects the attribute name candidate “due date”, attribute values set for the attribute name are displayed as attribute value candidates, as shown in FIG. 8B. In FIG. 8B, attribute values “7/4”, “7/5”, and “8/7” are displayed as candidates for the attribute name “due date”.

With regard to a reference date serving as the reference time point for displaying an attribute name, although the current date is set as an initial state, this reference date is changeable by the user.

Therefore, when the file management server 10 receives an operation for changing the reference date from the initial state in step S106, the reference date set by the user is input in step S107. Then, in step S108, the file management server 10 displays the attribute name candidates again based on the set reference date.

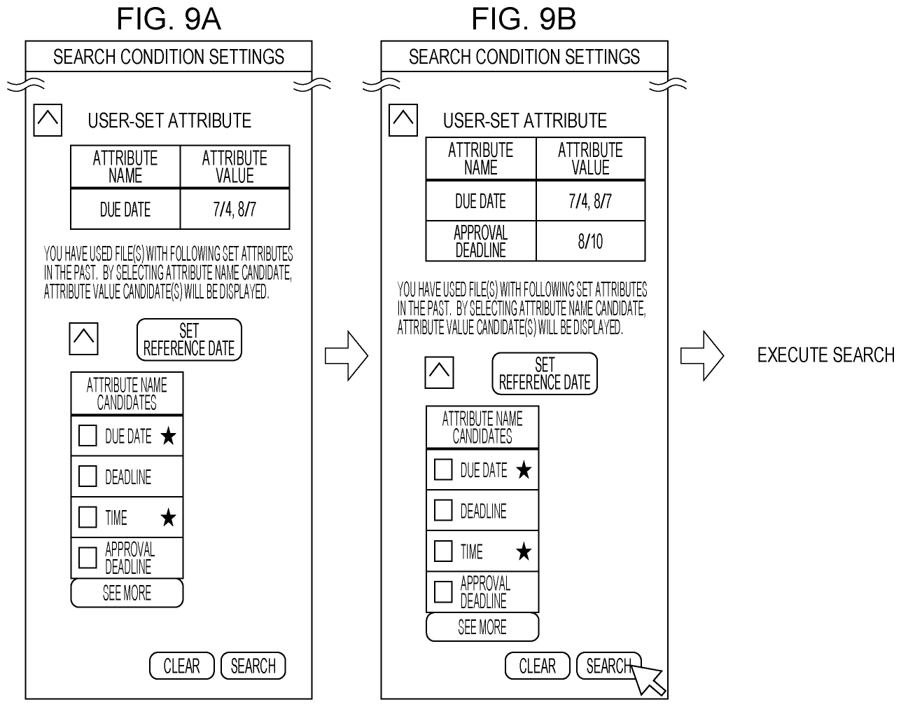

FIG. 8C illustrates a state where the user selects the attribute values “7/4” and “8/7” from the attribute value candidates on the search screen shown in FIG. 8B. FIG. 9A illustrates an example of an operation screen when the user selects an “add” button in FIG. 8C.

In the example of the operation screen shown in FIG. 9A, “due date” is set as an attribute name of the user-set attribute set as a search condition, and that two values, namely, “7/4” and “8/7”, are set as attribute values.

In step S109, the file management server 10 receives the attribute name and the attribute values serving as search conditions in accordance with the user operation described above.

When the user gives a search command as in the example of the operation screen shown in FIG. 9B, the file management server 10 executes a searching process in step S110 for searching for a file given the attribute name and the attribute values designated as search conditions from among the files stored in the file storage unit 36. In the search screen shown in FIG. 9B, an attribute name “approval deadline” and an attribute value “8/10” are input in accordance with an operation similar to when the attribute name “due date” is input.

Then, in step S111, the file management server 10 displays a file or files found in the searching process as a search result on the display screen of the terminal apparatus 20.

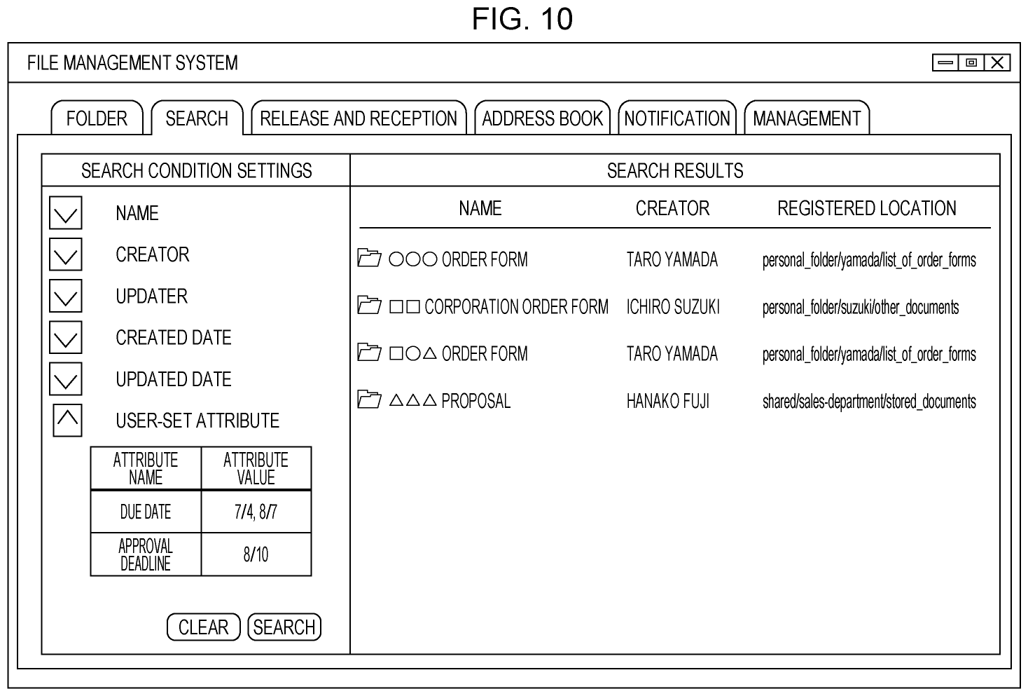

FIG. 10 illustrates an example of the display screen of the terminal apparatus 20 displaying search results in this manner. In the display screen shown in FIG. 10, four files given the user-set attributes designated as search conditions are displayed as search results.

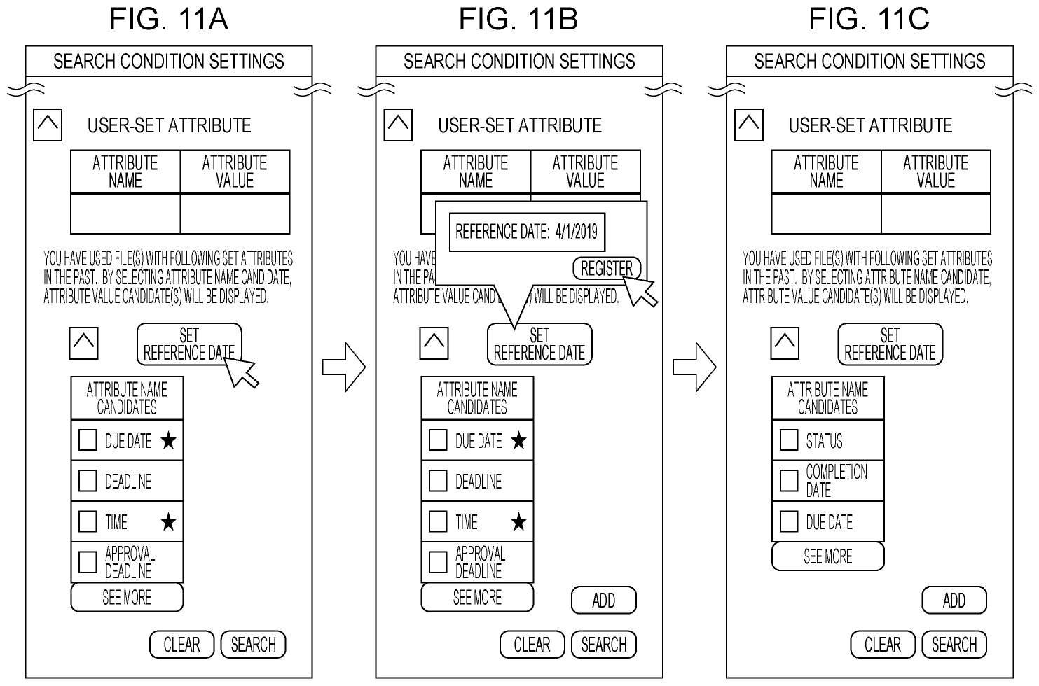

FIGS. 11A to 11C illustrate a state where an operation is performed by the user when setting the reference date in the search screen.

FIG. 11A illustrates a state where the user trying to set a past time point instead of the current date as the reference date selects a “set reference date” field. FIG. 11B illustrates a state where the user inputs “4/1/2019” as the reference date and operates a “register” button.

When the user performs the operations shown in FIGS. 11A and 11B to change the reference date to “4/1/2019” from the current date, attribute names to be displayed as candidates for the search condition are changed, as shown in FIG. 11C. Referring to FIG. 11C, attribute names “status”, “completion date”, and “due date” are displayed as attribute name candidates as a result of changing the reference date.

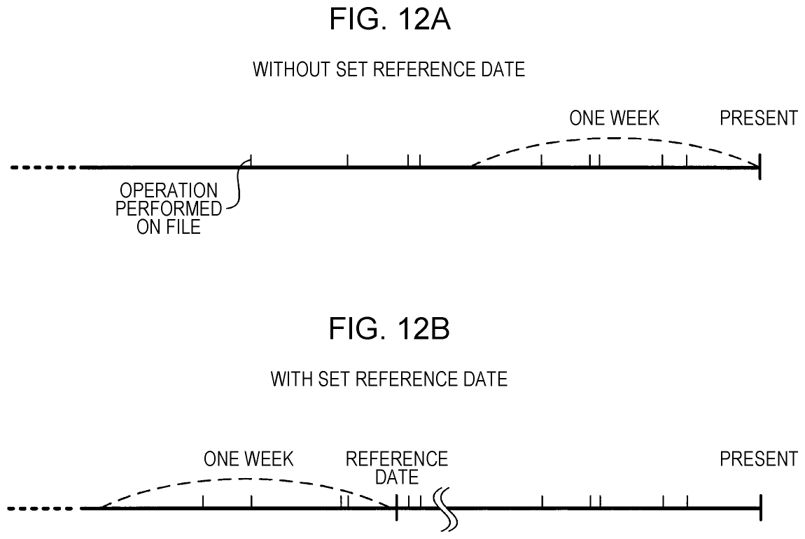

The reason that the attribute names displayed as candidates for the search condition are changed by changing the reference date in this manner will be described with reference to FIGS. 12A and 12B.

As shown in FIG. 12A, in a case where the user does not set a new reference date, since the current date is set as the reference date, an attribute name of a user-set attribute set to a file that has undergone an operation by the user within, for example, one previous week from the current date is displayed as a candidate for the search condition.

However, if the user sets a new date as a reference date by designating the reference date, an attribute name of a user-set attribute set for a file that has undergone an operation by the user within one previous week from the reference date is displayed as a candidate for the search condition, as shown in FIG. 12B.

Therefore, by changing the reference date, an attribute name to be displayed as a candidate for the search condition is also changed. The user may arbitrarily set the reference date in this manner so that, for example, even if the user forgets the storage location of a file browsed on about a certain date of a certain month, the user may still be capable of searching for the file by roughly remembering the browsed date.

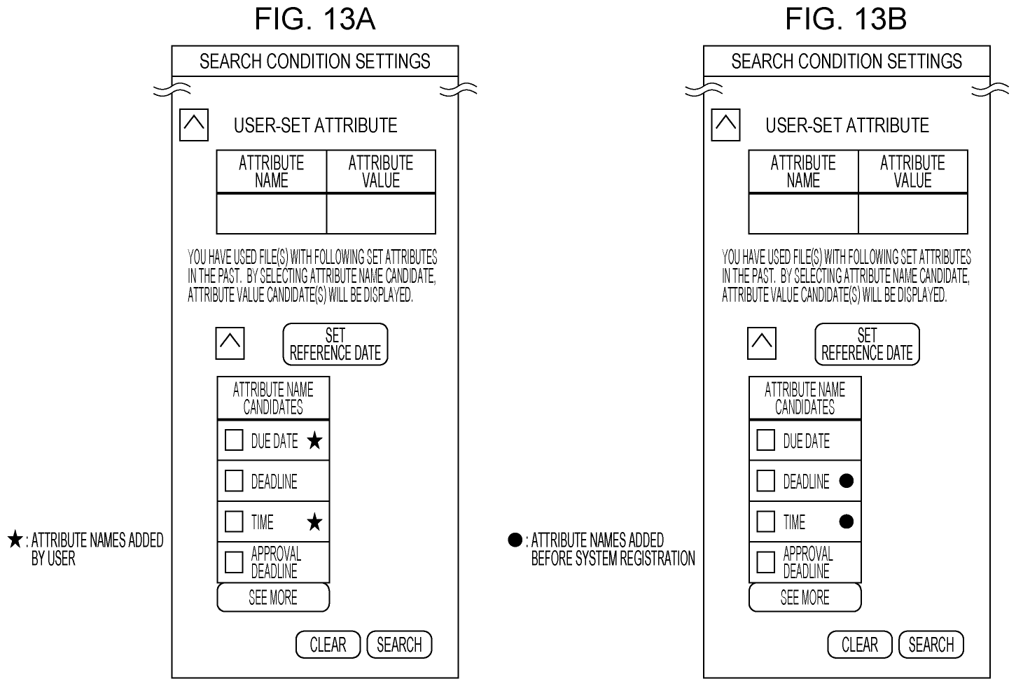

Next, the star symbols displayed next to the attribute names displayed as candidates for the search condition in, for example, FIGS. 8A to 8C, 9A and 9B, and 11A to 11C will be described. As shown in FIG. 13A, each of these star symbols indicates that the attribute name has been added by the user. An attribute name not having a star symbol next to it is an attribute name added by another user different from the relevant user.

FIG. 13B illustrates an example where attribute names displayed as candidates for the search condition are displayed such that it is clear whether or not the attribute names have been added before being stored in the file storage unit 36 of the system.

In the display example shown in FIG. 13B, black circular symbols are displayed next to attribute names displayed as candidates for the search condition. Each of these black circular symbols indicates that the attribute name has been preliminarily added to a file before the file is registered in the system. An attribute name not having a black circular symbol displayed next to it is an attribute name added after the file is registered in the system. Specifically, an attribute name not having a black circular symbol displayed next to it is an attribute name of a user-set attribute added to a file as a result of any of the users operating the corresponding terminal apparatus 20 after the file is registered in the file storage unit 36.

Although different contents are displayed in FIGS. 13A and 13B for simplifying the description, the contents shown in FIGS. 13A and 13B may be simultaneously displayed.

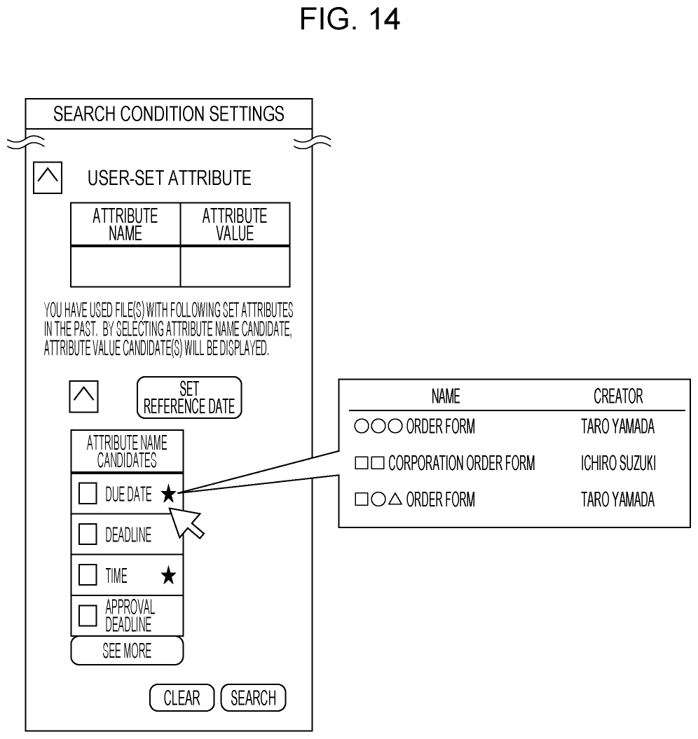

In the above-described exemplary embodiment, the searching process is executed by setting an attribute name as a search condition, so that a file given the attribute name is searched for, and a search result is displayed. Alternatively, without having to perform such a searching process, the user may simply perform a mouse-over operation on an attribute name displayed as a candidate for the search condition so that a list of files given the attribute name is displayed in a pop-up menu. FIG. 14 illustrates an example of a display screen when such a pop-up menu is displayed.

Referring to FIG. 14, when the user places the pointer of the mouse over the attribute name “due date” displayed as a candidate for the search condition, three files given the attribute name as a user-set attribute is displayed as a list in a pop-up menu.

In the exemplary embodiments above, the term “processor” refers to hardware in a broad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A file management apparatus comprising:
a memory configured to store a plurality of files in a state where a user-set attribute including an attribute name and an attribute value that are set by a user is added to each file; and
a processor configured to
cause a display device to display a screen when a user searches for any of the files by using an attribute name of the user-set attribute as a search condition, wherein, of the attribute names of the plurality of user-set attributes set to the plurality of files, the screen includes, in a selectable manner as a candidate for the search condition, an attribute name added to a file that has undergone an operation in the past by the user performing the search, and does not include an attribute name added only to a file that has never undergone an operation by the user performing the search.

2. The file management apparatus according to claim 1,
wherein the processor receives addition of a new user-set attribute to any of the files stored in the memory, and
wherein the screen displayed to the user performing the search includes an attribute name added to a file by a second user different from the user performing the search.

3. The file management apparatus according to claim 2,
wherein the processor displays the attribute names included in the screen so as to clearly indicate whether each attribute name has been added by the second user or by the user performing the search.

4. The file management apparatus according to claim 2,
wherein the processor displays the attribute names included in the screen so as to clearly indicate whether each attribute name has been added before the corresponding file is stored in the memory or after the corresponding file is stored in the memory.

5. The file management apparatus according to claim 1,
wherein, in response to an operation performed on the attribute name displayed as the candidate for the search condition before a command for executing the search is received, the processor displays a list of files given attribute information having the attribute name displayed as the candidate set therein.

6. The file management apparatus according to claim 5,
wherein the processor displays the list of files such that the list only includes files that have undergone an operation in the past by a user.

7. The file management apparatus according to claim 5,
wherein the processor displays the list of files such that the list includes a file that has undergone an operation in the past by a user with higher priority over a file that has never undergone an operation by the same user.

8. The file management apparatus according to claim 1,
wherein the memory stores files created by a plurality of users and operation history information indicating a history of operations performed on each of the files for each user, and
wherein the processor uses the operation history information to display, to the user performing the search, an attribute name added to a file that has, within a specific period, undergone an operation by the user performing the search.

9. The file management apparatus according to claim 8,
wherein the processor displays an attribute name added to a file that has undergone an operation by the user performing the search in a period after a set reference time point and before a preset period.

10. The file management apparatus according to claim 9,
wherein the reference time point is a current time point or a time point changed by the user.

11. A non-transitory computer readable medium storing a program causing a computer to execute a process, the process comprising:
storing a plurality of files in a state where a user-set attribute including an attribute name and an attribute value that are set by a user is added to each file; and
causing a display device to display a screen when a user searches for any of the files by using an attribute name of the user-set attribute as a search condition, wherein, of the attribute names of the plurality of user-set attributes set to the plurality of files, the screen includes, in a selectable manner as a candidate for the search condition, an attribute name added to a file that has undergone an operation in the past by the user performing the search, and does not include an attribute name added only to a file that has never undergone an operation by the user performing the search.

12. A file management apparatus comprising:
storing means for storing a plurality of files in a state where a user-set attribute including an attribute name and an attribute value that are set by a user is added to each file; and
processing means for causing a display device to display a screen when a user searches for any of the files by using an attribute name of the user-set attribute as a search condition, wherein, of the attribute names of the plurality of user-set attributes set to the plurality of files, the screen includes, in a selectable manner as a candidate for the search condition, an attribute name added to a file that has undergone an operation in the past by the user performing the search, and does not include an attribute name added only to a file that has never undergone an operation by the user performing the search.
